(19) United States
(12) Patent Application Publication
(10) Pub. No.: US 2015/0324619 A1
(43) Pub. Date: Nov. 12, 2015

(54) APPARATUS AND METHOD FOR CONTROLLING TAG

(71) Applicant: Electronics and Telecommunications Research Institute, Daejeon (KR)

(72) Inventors: Kwang-Soo CHO, Daejeon (KR); Chan-Won PARK, Daejeon (KR); Cheol-Sig PYO, Daejeon (KR); Kyu-Won HAN, Daejeon (KR)

(21) Appl. No.: 14/596,703

(22) Filed: Jan. 14, 2015

(30) Foreign Application Priority Data
May 12, 2014 (KR) 10-2014-0056763

(51) Int. Cl. G06K 7/10; H04L 1/08

(52) U.S. Cl. CPC G06K 7/10198; H04L 1/08

(57) ABSTRACT

Disclosed herein is an apparatus for controlling a tag including: a communication interface receiving a read request; a tag communicating unit connected to one or more memory tags and transmitting and receiving data; a memory storing instructions for performing reads for the memory tags; and a processor performing a control for the memory tags according to the read request based on the instructions, wherein the instructions include instructions for performing the steps of: transmitting a configuration information request to the memory tags; receiving configuration information from the memory tags; calculating the number of data segment according to the configuration information and transmitting the read request including the number of data segment to the memory tags; and receiving a data segment corresponding to the number of data segment from the memory tags.

### CROSS REFERENCE TO RELATED APPLICATION

This application claims the benefit of Korean Patent Application No. 10-2014-0056763, filed on May 12, 2014, entitled “Apparatus and Method for Controlling Tag”, which is hereby incorporated by reference in its entirety into this application.

### BACKGROUND OF THE INVENTION

1. Technical Field

The present invention relates to an apparatus for controlling a tag, and more particularly, to a technology for performing read, write, and function expire for memory tags by the apparatus for controlling the tag.

2. Description of the Related Art

In general, a radio identifying technology is a technology providing services of positioning for an object, remote processing, management, and information exchange between objects by attaching a tag to each object in each application stage and wirelessly recognizing unique identification (ID) of the object to thereby collect, store, process, and track the corresponding information. An ultra-high frequency (UHF) band passive radio frequency identification (RFID) system includes a tag having object information and a reader, wherein the tag forming the UHF band passive RFID system of 900 MHz receives carrier waves from the reader to generate self-power and performs communication with a tag controlling apparatus in a load-modulation scheme. Particularly, an RFID application field has gradually extended an area thereof from recognition of a pallet and box unit to a product recognition of individual unit. International Standards have been recently completed by UHF Gen2 international standard in which a high performance Gen2 protocol standard of the UHF band is adopted to the UHF band which is preferable to metal and liquid environments. However, a current tag does not have a tag memory with large capacity and in the future, in order to store history management data of aircraft parts and store the history management data for long hours, there is a need to provide tags having a mass memory. Currently, there are problems such as a low transmitting rate and performance limitation due to an error occurrence between tag readers when reading the mass memory.

### SUMMARY OF THE INVENTION

An object of the present invention is to provide an apparatus for controlling a tag capable of performing read or write depending on a degree capable of reading or writing data of a memory tag at one time.

According to an exemplary embodiment of the present invention, there is provided an apparatus for controlling a tag, including: a communication interface receiving a read request; a tag communicating unit connected to one or more memory tags and transmitting and receiving data; a memory storing instructions for performing reads for the memory tags; and a processor performing a control for the memory tags according to the read request based on the instructions, wherein the instructions include instructions for performing the steps of: transmitting a configuration information request to the memory tags; receiving configuration information from the memory tags; calculating the number of data segment according to the configuration information and transmitting the read request including the number of data segment to the memory tags; and receiving a data segment corresponding to the number of data segment from the memory tags.

The instructions may further include instructions for performing the steps of: determining whether or not an error due to the data segment occurs; retransmitting the read request to the memory tags when the error occurs; and re-receiving the data segment from the memory tags.

The instructions may further include instructions for performing the steps of: determining whether or not one or more tag identification information is included in the read request; and transmitting tag selecting instruction including the tag identification information to the memory tags when the tag identification information for the memory tags is included in the read request.

According to another exemplary embodiment of the present invention, there is provided an apparatus for controlling a tag, including: a communication interface receiving a write request; a tag communicating unit connected to one or more memory tags and transmitting and receiving data; a memory storing instructions for performing writes for the memory tags; and a processor performing a control for the memory tags according to the write request based on the instructions, wherein the instructions include instructions for performing the steps of: transmitting write instruction including data having capacity according to a write size unit to the memory tags; receiving write responses including a write size from the memory tags; updating the write size unit to the write size included in the write response when the write size included in the write response is different from the write size unit; and transmitting the write request including data having capacity according to the updated write size unit to the memory tags.

The instructions may further include instructions for performing the steps of: determining whether or not the write request is a write request for a plurality of tags; transmitting tag write inquiry instructions to the respective memory tags when the write request is the write request for the plurality of memory tags; receiving an inquiry response corresponding to the tag write inquiry instructions from the memory tags; and setting a write size unit corresponding to the memory tag according to a write size included in the inquiry response.

The instructions may further include instructions for performing the steps of: determining whether or not tag identification information included in the inquiry response and tag identification information of a subject memory tag are the same; retransmitting the tag write inquiry instructions when the tag identification information included in the inquiry response and the tag identification information of a subject memory tag are the same; and re-receiving the inquiry response corresponding to the tag write inquiry instructions from the memory tags, wherein the step of setting a write size unit corresponding to the memory tag according to a write size included in the inquiry response may be performed when the tag identification information included in the inquiry response and the tag identification information of a subject memory tag are different.

According to still another exemplary embodiment of the present invention, there is provided a method for controlling memory tags by an apparatus for controlling a tag, including: receiving a read request; transmitting a configuration information request to the memory tags; receiving configuration information from the memory tags; calculating the number of data segment according to the configuration information and transmitting the read request including the number of data segment to the memory tags; and receiving a data segment corresponding to the number of data segment from the memory tags.

The method may further include: determining whether or not an error due to the data segment occurs; retransmitting the read request to the memory tags when the error occurs; and re-receiving the data segment from the memory tags.

The method may further include: determining whether or not one or more tag identification information is included in the read request; and transmitting tag selecting instruction including the tag identification information to the memory tags when the tag identification information for the memory tags is included in the read request.

According to still yet another exemplary embodiment of the present invention, there is provided a method for controlling a tag by an apparatus for controlling the tag, including: receiving a read request; transmitting write instruction including data having capacity according to a write size unit to memory tags; receiving write responses including a write size from the memory tags; updating the write size unit to the write size included in the write response when the write size included in the write response is different from the write size unit; and transmitting the write request including data having capacity according to the updated write size unit to the memory tags.

The method may further include: determining whether or not the write request is a write request for a plurality of tags; transmitting tag write inquiry instructions to the respective memory tags when the write request is the write request for the plurality of memory tags; receiving an inquiry response corresponding to the tag write inquiry instructions from the memory tags; and setting a write size unit corresponding to the memory tag according to a write size included in the inquiry response.

The method may further include: determining whether or not tag identification information included in the inquiry response and tag identification information of a subject memory tag are the same; retransmitting the tag write inquiry instructions when the tag identification information included in the inquiry response and the tag identification information of a subject memory tag are the same; and re-receiving the inquiry response corresponding to the tag write inquiry instructions from the memory tags, wherein the setting of the write size unit corresponding to the memory tag according to the write size included in the inquiry response is performed when the tag identification information included in the inquiry response and the tag identification information of a subject memory tag are different.

### BRIEF DESCRIPTION OF THE DRAWINGS

FIG. 1 is a view illustrating an apparatus for controlling a tag according to an exemplary embodiment of the present invention;

FIG. 2 is a view illustrating a memory tag according to an exemplary embodiment of the present invention;

FIG. 3 is a flowchart illustrating processes in which the apparatus for controlling the tag according to the exemplary embodiment of the present invention reads data stored in the memory tag;

FIG. 4 is a view illustrating processes in which the apparatus for controlling the tag according to the exemplary embodiment of the present invention reads data stored in the memory tag; and

FIG. 5 is a flowchart illustrating processes in which the apparatus for controlling the tag according to the exemplary embodiment of the present invention writes data in the memory tag.

FIG. 6 is a computer system according to an embodiment of the present invention may be implemented in a computer system.

### DESCRIPTION OF THE EXEMPLARY EMBODIMENTS

Since the present invention may be variously modified and have several exemplary embodiments, specific exemplary embodiments will be shown in the accompanying drawings and be described in detail in a detailed description. However, it is to be understood that the present invention is not limited to a specific exemplary embodiment, but includes all modifications, equivalents, and substitutions without departing from the scope and spirit of the present invention.

Further, in the present specification, it is to be understood that when one component is referred to as “transmitting” a signal to another component, one component may be directly connected to another component to transmit a signal to another component or may transmit a signal to another component through any other components unless explicitly described to the contrary.

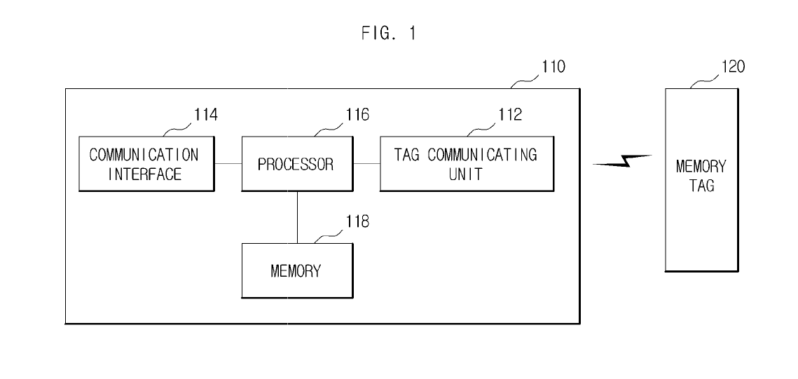

FIG. 1 is a view illustrating an apparatus for controlling a tag according to an exemplary embodiment of the present invention.

Referring to FIG. 1, an apparatus 110 for controlling a tag according to an exemplary embodiment of the present invention may include a tag communicating unit 112, a communication interface 114, a processor 116, and a memory 118.

The tag communicating unit 112 may be connected to a memory tag 120 and receive data from the memory tag 120. For example, the tag communicating unit 112 may receive configuration information and memory data of the memory tag 120 from the memory tag 120. In this case, the configuration information may include a segment size (hereinafter, referred to as a single transmitting size) which may be transmitted at one time and a user memory size included in the tag. In addition, the tag communicating unit 112 may transmit data to the memory tag 120. For example, the tag communicating unit 112 may transmit a read request, a write request, and a function expire request for the memory tag 120 to the memory tag 120. The read request, the write request, and the function expire request transmitted by the tag communicating unit 112 will be described below in detail.

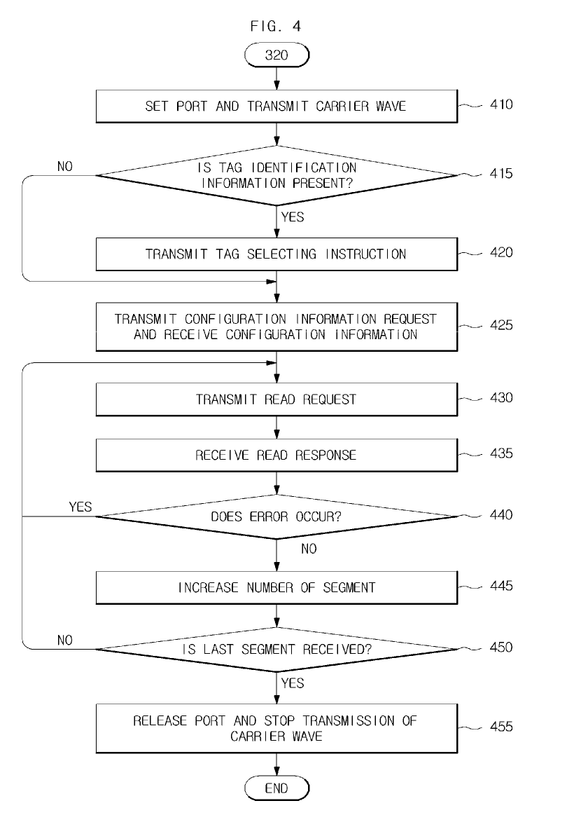

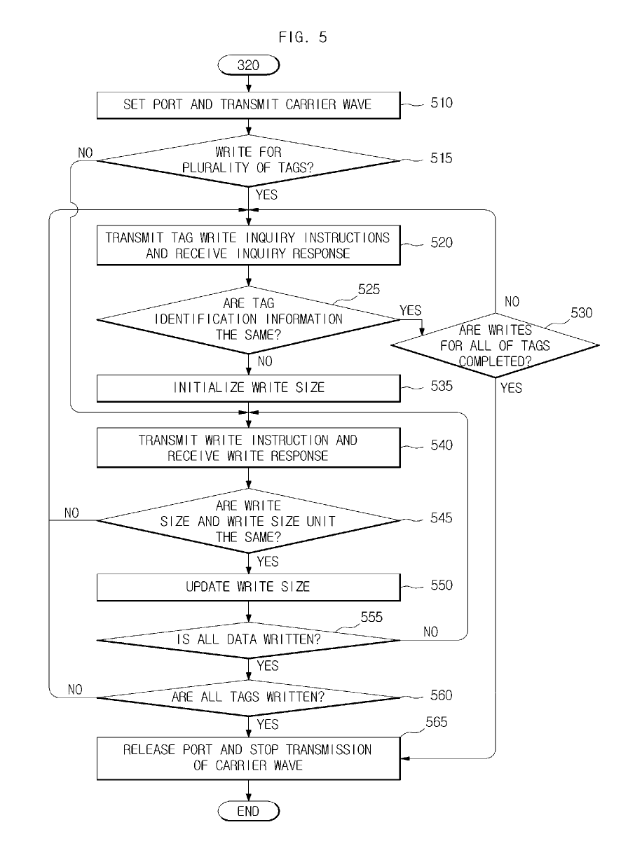

The communication interface 114 may receive a service request through a known communication protocol such as an Ethernet, or the like, and transmit the service request to the processor 116. In this case, the service request may be the read request, the write request, or the function expire request for the memory tag 120. The read request, the write request, and the function expire request, respectively, will be described below in detail with reference to FIGS. 4 and 5.

The processor 116 may perform processes for reading, writing, or function-expiring data of the memory tag 120 based on the configuration information of the memory tag 120 according to instructions stored in the memory 118.

The memory 118 may store instructions for reading, writing, and function-expiring the data of the memory tag 120 based on the configuration information of the memory tag 120.

The processor 116 may perform the respective processes based on the instructions stored in the memory 118.

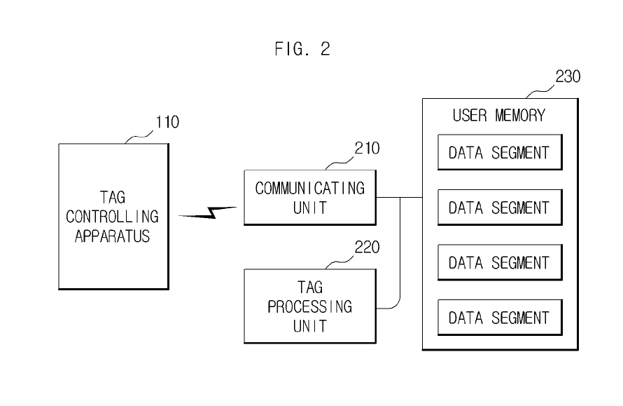

FIG. 2 is a view illustrating a memory tag according to an exemplary embodiment of the present invention.

Referring to FIG. 2, a memory tag 120 according to an exemplary embodiment of the present invention may include a communicating unit 210, a tag processing unit 220, and a user memory 230.

The communicating unit 210 may receive the read request, the write request, or the function expire request from the apparatus 110 for controlling the tag. In addition, the communicating unit 210 may transmit data stored in the corresponding memory tag 120 to the apparatus 110 for controlling the tag.

The tag processing unit 220 stores configuration information on the corresponding memory tag 120. In the case in which the tag processing unit 220 receives a configuration information request requesting the configuration information through the communicating unit 210, it may transmit the configuration information to the apparatus 110 for controlling the tag through the communicating unit 210. In this case, the tag processing unit may pre-store a preset user memory encryption, a total size of the user memory 230, a size of the user memory 230 which is currently used (has data stored therein), a size of a data segment, the number of data segments, and one or more of full discard which is a scheme prohibiting a use of the memory tag 120, user memory discard which is a scheme discarding only the user memory among the memory tags 120, and a flag indicating an expiration of all memory writing functions which is a scheme prohibiting a writing function for the memory tag 120, and may include a portion or all of the pre-stored information in the configuration information.

The user memory 230 may partition and store the data into preset data segment units. As the memory 118 receives the read request, the write request, or the function expire request which are received through the communicating unit, it may read the data segments and transmit the data segment to the apparatus 110 for controlling the tag, write data included in the write request, or expire the function of one or more of the data segments according to the function expire request.

Hereinafter, processes in which the processor 116 of the apparatus for controlling the tag according to an exemplary embodiment of the present invention reads, writes, and function-expires according to the instructions will be described in detail.

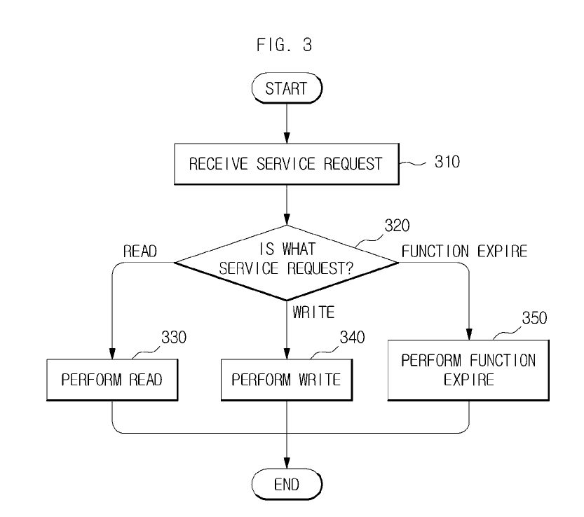

FIG. 3 is a flowchart illustrating processes in which the apparatus for controlling the tag according to the exemplary embodiment of the present invention reads data stored in the memory tag.

Referring to FIG. 3, in operation 310, the apparatus 110 for controlling the tag may receive the service request through the communication interface 114.

In operation 320, the apparatus 110 for controlling the tag may determine whether the service request is any one of the read request, the write request, and the function expire request.

In operation 330, in the case in which the service request is the read request, the apparatus 110 for controlling the tag may perform a read process for the memory tag 120. The read process will be described below in detail with reference to FIG. 4.

In operation 340, in the case in which the service request is the write request, the apparatus 110 for controlling the tag may perform a write process for the memory tag 120. The write process will be described below in detail with reference to FIG. 5.

In operation 350, in the case in which the service request is the function expire request, the apparatus 110 for controlling the tag may perform a function expire process for the memory tag 120. In this case, the apparatus 110 for controlling the tag may include one or more of the full discard which is the scheme prohibiting the use of the memory tag 120, the user memory discard which is a scheme discarding only the user memory among the memory tags 120, and the flag indicating the expiration of all memory writing functions which is the scheme prohibiting the writing function for the memory tag 120 in the function expire request. Therefore, in the case in which the memory tag 120 receives the function expire request, it may be set so as to fully stop a function of the memory tag 120 according to the respective flags included in the function expire request, transmit a response according to the instructions of the apparatus 110 for controlling the tag but not to provide read and write functions for the user memory 230, or provide the read function according to the instructions of the apparatus 110 for controlling the tag but not to provide the write function.

As described with reference to FIG. 3, the apparatus 110 for controlling the tag may perform any one of the read, write, and function expire processes according to the service request. Hereinafter, each of the read process, the write process, and the function expire process will be respectively described in detail with reference to FIGS. 4 and 5.

FIG. 4 is a view illustrating processes in which the apparatus for controlling the tag according to the exemplary embodiment of the present invention reads data stored in the memory tag. The respective processes described below are processes in which the processor 116 of the apparatus 110 for controlling the tag is operated according to the instructions stored in the memory 118 and the subject of the description is collectively referred to as the apparatus 110 for controlling the tag in order to obviously and briefly describe the present invention. In addition, a process described below with reference to FIG. 4 may be a process of the operation 330 of FIG. 3.

Referring to FIG. 4, in operation 410, the apparatus 110 for controlling the tag may set a port of the tag communicating unit 112 which will perform transmission and reception with the memory tag 120 and set the tag communicating unit 112 so as to transmit carrier waves.

In operation 420, the apparatus 110 for controlling the tag may determine whether or not tag identification information of the memory tag 120 is included in the read request. That is, the apparatus 110 for controlling the tag may determine whether the read request requests the read for a specific memory tag 120.

In operation 420, in the case in which the tag identification information for the memory tag 120 is included in the read request, the apparatus 110 for controlling the tag may transmit a tag selecting instruction including the corresponding tag identification information to the memory tag 120.

In operation 420, in the case in which the tag identification information for the memory tag 120 is not included in the read request, in operation 425, the apparatus 110 for controlling the tag may transmit a configuration information request requesting configuration information of the memory tag 120 to the respective memory tags 120. In this case, when one or more memory tags 120 are connected to the apparatus 110 for controlling the tag and the respective memory tags 120 receive the tag selecting instruction from the apparatus 110 for controlling the tag, the respective memory tags 120 may transmit the configuration information according to the configuration information request in the case in which the tag identification information included in the tag selecting instruction is equal to the tag identification information of the memory tag 120. On the other hand, when a plurality of memory tags 120 are connected to the apparatus 110 for controlling the tag and the tag identification information included in the tag selecting instruction is different from the tag identification information of the memory tag 120, the respective memory tags 120 may respectively transmit own configuration information to the apparatus 110 for controlling the tag. Therefore, in the case in which the read request is the read request for the specific memory tag 120, the apparatus 110 for controlling the tag may rapidly receive the configuration information of the corresponding memory tag 120.

In operation 430, the apparatus 110 for controlling the tag may transmit the read request to the respective memory tags 120 by which the configuration information is transmitted. For example, the apparatus 110 for controlling the tag may calculate the number of data segment which is necessary for the memory tag 120 depending on a user memory size and a single transmitting size included in the configuration information and transmit the read request including the number of corresponding data segment to the memory tag 120 through the tag communicating unit 112. In this case, the apparatus 110 for controlling the tag may generate a read request of 48 to 50 bits shorter than conventional Gen2 instructions (instructions having 58 bits at a minimum and 72 bits at a maximum). For example, since the Gen2 instructions include instructions (8 bits), a memory bank (2 bits), a word pointer (8 to 24 bits), a word counter (8 bits), a random number (16 bits), and bits for an error check (16 bits), it may be formed in 58 to 72 bits. However, since the read request according to the present invention includes instructions (8 bits), an option memory bank (2 bits), the number of data segment (8 bits), a random number (16 bits), and bits for an error check (16 bits), it may be formed in 48 to 50 bits.

In operation 435, the apparatus 110 for controlling the tag may receive a read response from the memory tag 120. In this case, the read response may include a data segment corresponding to the number of data segment included in the read request (hereinafter, referred to as a segment number), the segment number included in the read response, and stored cyclic redundancy check (CRC) information.

In operation 440, the apparatus 110 for controlling the tag may perform a known CRC-16 check, and the stored CRC check, a segment number check determining whether or not the segment number included in the read response and the segment number included in the read request are the same, and verify whether an error occurs in the respective check processes.

In operation 440, in the case in which the error occurs, the apparatus 110 for controlling the tag may repeatedly perform the processes from the operation 430.

In operation 440, in the case in which the error does not occur, in operation 445, the apparatus 110 for controlling the tag may increase a subject segment number, which is the number of data segment in which the read process is currently performed. In this case, the subject segment number may have an initial value which is preset to 1. For example, in operation 440, in the case in which the subject segment number is 1, in operation 450, the apparatus 110 for controlling the tag may increase the segment number to 2.

In operation 450, the apparatus 110 for controlling the tag may verify whether a last data segment is received. That is, in the case in which the current subject segment number exceeds the number of last data segment, the apparatus 110 for controlling the tag may determine that the data segment which is recently received in operation 435 is the last data segment.

In operation 450, in the case in which it is verified that the last data segment is not received, the apparatus 110 for controlling the tag may repeatedly perform the processes from the operation 430.

In operation 450, in the case in which it is verified that the last data segment is received, in operation 455, the apparatus 110 for controlling the tag may release the port set in operation 410 and stop the transmission of the carrier waves.

Therefore, the apparatus 110 for controlling the tag according to an exemplary embodiment of the present invention may receive the configuration information from the memory tag 120 and transmit the read instructions including the number of data segment set in the memory tag 120 according to the configuration information to the memory tag 120. Accordingly, since the memory tag 120 transmits the data to the apparatus 110 for controlling the tag in a data segment unit of the user memory 230, it may transmit an amount of data that may be transmitted at one time by the corresponding memory tag 120 at one time. Accordingly, the number of times that the instructions and the responses are transmitted and received between the apparatus 110 for controlling the tag and the memory tag 120 is minimized, such that a transmitting amount of information for transmitting data except for the data such as the instructions, or the like may be decreased and a waiting time occurring between the transmission and the reception of the instructions and the responses may be decreased. As a result, the apparatus 110 for controlling the tag according to an exemplary embodiment of the present invention may decrease time taken to read the entire data stored in the memory tag 120.

FIG. 5 is a flowchart illustrating processes in which the apparatus for controlling the tag according to the exemplary embodiment of the present invention writes data in the memory tag. A process described below with reference to FIG. 5 may be a process of the operation 340 of FIG. 3. In this case, the write request may include data to be written in the memory tag 120 and tag identification information on the tag in which the write is to be performed.

Referring to FIG. 5, in operation 510, the apparatus 110 for controlling the tag may set a port of the tag communicating unit 112 which will perform transmission and reception with the memory tag 120 and set the tag communicating unit 112 so as to transmit carrier waves.

In operation 515, the apparatus 110 for controlling the tag may determine whether or not a write request is a write request for a plurality of tags. For example, the apparatus 110 for controlling the tag may verify whether tag identification information on the memory tag 120 included in the write request is plural.

In operation 515, in the case in which the write request is the write request for the plurality of tags, in operation 520, the apparatus 110 for controlling the tag may transmit tag write inquiry instructions to the respective memory tags 120 and receive inquiry responses. In this case, the inquiry response may include the tag identification information of the corresponding memory tag 120. In addition, the inquiry response may further include a write size indicating a length of data capable of being written in one write process. In addition, in the case in which the apparatus 110 for controlling the tag receives the inquiry responses corresponding to the tag write inquiry instructions from the plurality of memory tags 120, it may perform the following processes only for an initially received inquiry response. That is, the apparatus 110 for controlling the tag may select the memory tag 120 corresponding to the initially received inquiry response as a subject memory tag, which is a memory tag to which a current write process is to be applied.

In operation 525, the apparatus 110 for controlling the tag may determine whether or not tag identification information included in the inquiry response and tag identification information included in the write request is the same. That is, the apparatus 110 for controlling the tag may determine whether or not the write for the corresponding tag identification information is completed.

In operation 525, in the case in which the tag identification information included in the inquiry response and the tag identification information included in the write request are the same, in operation 530, the apparatus 110 for controlling the tag may determine whether or not the write processes for all of the memory tags 120 are completed.

In operation 530, in the case in which the write processes for all of the memory tags 120 are not completed, the apparatus 110 for controlling the tag may repeatedly perform the processes from the operation 520.

In operation 530, in the case in which the write processes for all of the memory tags 120 are completed, in operation 565, the apparatus 110 for controlling the tag may release the port set in operation 510 and stop the transmission of the carrier waves.

In operation 525, in the case in which the tag identification information included in the inquiry response and the tag identification information included in the write request are not the same, in operation 535, the apparatus 110 for controlling the tag may then set a write size unit indicating a length of data to be written in the memory tag 120 at one time. That is, in the case in which the memory tag 120 by which the inquiry response is transmitted does not yet perform the write process, the apparatus 110 for controlling the tag may set the write size unit. For example, in the case in which the write size is included in the inquiry response for the tag write inquiry instructions, the apparatus 110 for controlling the tag may initialize the write size unit to the write size included in the inquiry response. In this case, the write size unit may be a value set to an initial value, which is 1 before it is set in operation 535 (here, 1 means that the write is performed in a 1 word unit).

In operation 540, the apparatus 110 for controlling the tag may transmit write instruction including data having capacity corresponding to the write size unit and identification information of the subject memory tag to the memory tag 120 and receive the write response from the memory tag 120. In this case, the memory tag 120 may include tag identification information of the subject memory tag included in the write instruction.

The write response may include a write size of the memory tag 120 by which the corresponding write response is transmitted.

In operation 545, the apparatus 110 for controlling the tag may determine whether or not the write size included in the write response is equal to a preset write size unit.

In operation 545, in the case in which the write size included in the write response is equal to the preset write size unit, the apparatus 110 for controlling the tag may repeatedly perform the processes from the operation 540.

In operation 545, in the case in which the write size included in the write response is different from the preset write size unit, in operation 550, the apparatus 110 for controlling the tag may update the write size unit to the write size included in the write response.

In operation 555, the apparatus 110 for controlling the tag may determine whether or not a data write for the memory tag 120 in which the write process is currently performed is completed.

In operation 555, in the case in which the data write for the memory tag 120 in which the write process is currently performed is not completed, the apparatus 110 for controlling the tag may repeatedly perform the processes from the operation 540.

In operation 555, in the case in which the data write for the memory tag 120 in which the write process is currently performed is completed, in operation 560, the apparatus 110 for controlling the tag may determine whether or not the data writes for all of the memory tags are completed.

In operation 560, in the case in which the data writes for all of the memory tags are not completed, the apparatus 110 for controlling the tag may repeatedly perform the processes from the operation 520.

In operation 560, in the case in which the data writes for all of the memory tags are completed, in operation 565, the apparatus 110 for controlling the tag may release the port set in operation 510 and stop the transmission of the carrier waves.

Therefore, the apparatus 110 for controlling the tag according to an exemplary embodiment of the present invention may perform the write by setting the write size unit according to a data amount capable of being written in the memory tag 120 at one time and transmitting the data to the tag according to the write size unit. Accordingly, the number of times that the instructions and the responses are transmitted and received between the apparatus 110 for controlling the tag and the memory tag 120 is minimized, such that a transmitting amount of information for transmitting data except for the data such as the instructions, or the like may be decreased and a waiting time occurring between the transmission and the reception of the instructions and the responses may be decreased. As a result, the apparatus 110 for controlling the tag according to an exemplary embodiment of the present invention may decrease time taken to write the entire data in the memory tag 120.

In addition, when the memory tag 120 in which the write process is to be performed is plural, the apparatus 110 for controlling the tag according to an exemplary embodiment of the present invention may transmit the tag write inquiry instructions to the respective memory tags 120, may perform the write process based on the received initial inquiry response, and may not redundantly perform the write process for the memory tag 120 in which the write process is already completed, by comparing the tag identification information.

As set forth above, according to exemplary embodiments of the present invention, the time taken by the memory tag to performing the read or write may be decreased by allowing the memory tag to read to write a suitable amount of data at one time.

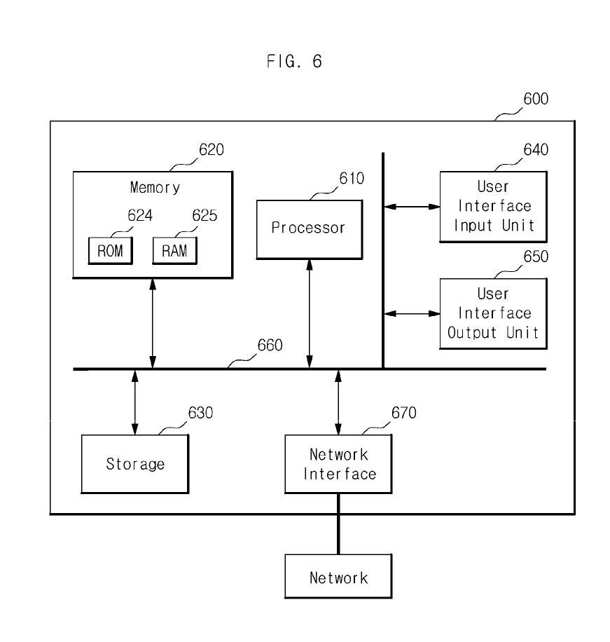

An embodiment of the present invention may be implemented in a computer system, e.g., as a computer readable medium. As shown in FIG. 6, a computer system 620-1 may include one or more of a processor 621, a memory 623, a user input device 626, a user output device 627, and a storage 628, each of which communicates through a bus 622. The computer system 620-1 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory (RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

Hereinabove, the present invention has been described with reference to exemplary embodiments thereof. Many exemplary embodiments other than the above-mentioned exemplary embodiments fall within the scope of the present invention. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. An apparatus for controlling a tag, the apparatus comprising:
a communication interface receiving a read request;
a tag communicating unit connected to one or more memory tags and transmitting and receiving data;
a memory storing instructions for performing reads for the memory tags; and
a processor performing a control for the memory tags according to the read request based on the instructions,
wherein the instructions include instructions for performing the steps of:
transmitting a configuration information request to the memory tags;
receiving configuration information from the memory tags;
calculating the number of data segment according to the configuration information and transmitting the read request including the number of data segment to the memory tags; and
receiving a data segment corresponding to the number of data segment from the memory tags.

2. The apparatus of claim 1, wherein the instructions further include instructions for performing the steps of:
determining whether or not an error due to the data segment occurs;
retransmitting the read request to the memory tags when the error occurs; and
re-receiving the data segment from the memory tags.

3. The apparatus of claim 1, wherein the instructions further include instructions for performing the steps of:
determining whether or not one or more tag identification information is included in the read request; and
transmitting tag selecting instruction including the tag identification information to the memory tags when the tag identification information for the memory tags is included in the read request.

4. An apparatus for controlling a tag, the apparatus comprising:
a communication interface receiving a write request;
a tag communicating unit connected to one or more memory tags and transmitting and receiving data;
a memory storing instructions for performing writes for the memory tags; and
a processor performing a control for the memory tags according to the write request based on the instructions,
wherein the instructions include instructions for performing the steps of:
transmitting write instruction including data having capacity according to a write size unit to the memory tags;
receiving write responses including a write size from the memory tags;
updating the write size unit to the write size included in the write response when the write size included in the write response is different from the write size unit; and
transmitting the write request including data having capacity according to the updated write size unit to the memory tags.

5. The apparatus of claim 4, wherein the instructions further include instructions for performing the steps of:
determining whether or not the write request is a write request for a plurality of tags;
transmitting tag write inquiry instructions to the respective memory tags when the write request is the write request for the plurality of memory tags;
receiving an inquiry response corresponding to the tag write inquiry instructions from the memory tags; and
setting a write size unit corresponding to the memory tag according to a write size included in the inquiry response.

6. The apparatus of claim 5, wherein the instructions further include instructions for performing the steps of:
determining whether or not tag identification information included in the inquiry response and tag identification information of a subject memory tag are the same;
retransmitting the tag write inquiry instructions when the tag identification information included in the inquiry response and the tag identification information of a subject memory tag are the same; and
re-receiving the inquiry response corresponding to the tag write inquiry instructions from the memory tags,
the step of setting a write size unit corresponding to the memory tag according to a write size included in the inquiry response is performed when the tag identification information included in the inquiry response and the tag identification information of a subject memory tag are different.

7. A method for controlling memory tags by an apparatus for controlling a tag, the method comprising:
receiving a read request;
transmitting a configuration information request to the memory tags;
receiving configuration information from the memory tags;
calculating the number of data segment according to the configuration information and transmitting the read request including the number of data segment to the memory tags; and
receiving a data segment corresponding to the number of data segment from the memory tags.

8. The method of claim 7, further comprising:
determining whether or not an error due to the data segment occurs;
retransmitting the read request to the memory tags when the error occurs; and
re-receiving the data segment from the memory tags.

9. The method of claim 7, further comprising:
determining whether or not one or more tag identification information is included in the read request; and
transmitting tag selecting instruction including the tag identification information to the memory tags when the tag identification information for the memory tags is included in the read request.

10. A method for controlling a tag by an apparatus for controlling the tag, the method comprising:
receiving a read request;
transmitting write instruction including data having capacity according to a write size unit to memory tags;
receiving write responses including a write size from the memory tags;
updating the write size unit to the write size included in the write response when the write size included in the write response is different from the write size unit; and
transmitting the write request including data having capacity according to the updated write size unit to the memory tags.

11. The method of claim 10, further comprising:
determining whether or not the write request is a write request for a plurality of tags;
transmitting tag write inquiry instructions to the respective memory tags when the write request is the write request for the plurality of memory tags;
receiving an inquiry response corresponding to the tag write inquiry instructions from the memory tags; and
setting a write size unit corresponding to the memory tag according to a write size included in the inquiry response.

12. The method of claim 11, further comprising:
determining whether or not tag identification information included in the inquiry response and tag identification information of a subject memory tag are the same;
retransmitting the tag write inquiry instructions when the tag identification information included in the inquiry response and the tag identification information of a subject memory tag are the same; and
re-receiving the inquiry response corresponding to the tag write inquiry instructions from the memory tags,
wherein the setting of the write size unit corresponding to the memory tag according to the write size included in the inquiry response is performed when the tag identification information included in the inquiry response and the tag identification information of a subject memory tag are different.
